(19) United States
(12) Patent Application Publication
(10) Pub. No.: US 2026/0237179 A1
(43) Pub. Date: Aug. 13, 2026

(54) DISENTANGLED OBJECT-CENTRIC IMAGE REPRESENTATION FOR ROBOTIC MANIPULATION

(71) Applicant: NAVER CORPORATION, Gyeonggi-do (KR)

(72) Inventors: David EMUKPERE, Grenoble (FR); Romain DEFFAYET, La Tronche (FR); Bingbing WU, Villard-Bonnot (FR); Romain BRÉGIER, Bougnon (FR); Michael NIEMAZ, Saint Pierre d'Allevard (FR); Jean-Luc MEUNIER, St Nazaire les Eymes (FR); Denys PROUX, Vif (FR); Jean-Michel RENDERS, Quaix en Chartreuse (FR); Seungsu KIM, Meylan (FR)

(73) Assignee: NAVER CORPORATION, Gyeonggi-do (KR)

(21) Appl. No.: 19/417,697

(22) Filed: Dec. 12, 2025

Related U.S. Application Data
(60) Provisional application No. 63/757,998, filed on Feb. 13, 2025.

(51) Int. Cl. G06V 10/26; B25J 9/16; G06V 10/82

(52) U.S. Cl. CPC G06V 10/26; B25J 9/163; B25J 9/1697; G06V 10/82

(57) ABSTRACT

A robot control method for performing a task includes: segmenting images into (a) one or more first portions that include the robot, (b) one or more second portions that include an object of interest to performing the task, and (c) one or more third portions that include an obstacle; masking portions of the images; encoding the masked images; aggregating the encodings; determining an action to be taken by the robot for completing the task based on the aggregated encodings; and actuating the robot based on the action.

### CROSS-REFERENCE TO RELATED APPLICATIONS

This application claims the benefit of U.S. Provisional Application No. 63/757,998, filed on Feb. 13, 2025. The entire disclosure of the application referenced above is incorporated herein by reference.

### FIELD

The present disclosure relates to robots and more particularly to systems and methods for object recognition and robot articulation using images from two or more different cameras.

### BACKGROUND

The background provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are one type of robot and are an example of an autonomous system that is mobile and may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants/humans from a pickup to a destination. Another example of a navigating robot is a robot used to perform one or more functions inside a residential space (e.g., a home).

Other types of robots are also available, such as residential robots configured to perform various domestic tasks, such as putting liquid in a cup, filling a coffee machine, etc.

### SUMMARY

In a feature, a robot control system for performing a task includes: a first segmentation module configured to: receive a first image from a first camera of the robot having a first point of view; and segment the first image into (a) one or more first portions of the first image that include the robot, (b) one or more second portions of the first image that include an object of interest to performing the task, and (c) one or more third portions of the first image that include an obstacle; a second segmentation module configured to: receive a second image from a second camera of the robot having a second point of view, the second point of view different than the first point of view; and segment the second image into (a) one or more fourth portions of the second image that include the robot, (b) one or more fifth portions of the second image that include the object of interest, and (c) one or more sixth portions of the image that include the obstacle; a first masking and encoding module configured to: mask the first image and produce (a) a first masked image including the one or more first portions of the first image that include the robot, (b) a second masked image including the one or more second portions of the first image that include the object of interest, and (c) a third masked image including the one or more third portions of the first image that include the obstacle; and encode the first, second, and third masked images into first, second, and third encodings, respectively; a second masking and encoding module configured to: mask the second image and produce (a) a fourth masked image including the one or more fourth portions of the second image that include the robot, (b) a fifth masked image including the one or more fifth portions of the second image that include the object of interest, and (c) a sixth masked image including the one or more sixth portions of the second image that include the obstacle; and encode the fourth, fifth, and sixth masked images into fourth, fifth, and sixth encodings, respectively; one or more of a first aggregator module and a second aggregator module configured to (i) aggregate the first, second, and third encodings into a seventh encoding and to (ii) aggregate the fourth, fifth, and sixth encodings into an eighth encoding; a neural network module configured to determine an action to be taken by the robot for completing the task based on the seventh and eighth encodings; and a control module configured to actuate the robot based on the action.

In further features, a third aggregator module is configured to aggregate the seventh and eighth encodings into a ninth encoding, where the neural network module is configured to determine the action to be taken by the robot for completing the task based on the ninth encoding.

In further features, the third aggregator module is configured to generate the ninth encoding by concatenating the seventh and eighth encodings.

In further features: the first aggregator module is configured to generate the seventh encoding by concatenating the first, second, and third encodings; and the second aggregator module is configured to generate the eighth encoding by concatenating the fourth, fifth, and sixth encodings.

In further features: the first segmentation module is configured to segment the first image using a DINOv2 model; and the second segmentation module is configured to segment the second image using the DINOv2 model.

In further features, the neural network module is configured to determine the action using skill policies.

In further features, the skill policies include multi-layer perceptrons (MLPs).

In further features, the neural network module is configured to determine the action further based on at least one of: (a) one or more measurements from one or more sensors of the robot and (b) proprioception of the robot.

In further features, the neural network module is configured to determine the action further based on at least one of (a) one or more joint positions, (b) one or more joint velocities, (c) an end-effector pose, (d) previous instance of the action from a previous time, and (e) a grasp status.

In further features, the first masking and encoding module includes: a first masking module configured to mask the first image and thereby produce the first masked image including the one or more first portions of the first image that include the robot; a second masking module configured to mask the first image and thereby produce the second masked image including the one or more second portions of the first image that include the object of interest; and a third masking module configured to mask the first image and thereby produce the third masked image including the one or more third portions of the first image that include the obstacle.

In further features, the second masking and encoding module includes: a fourth masking module configured to mask the second image and thereby produce the fourth masked image including the one or more fourth portions of the second image that include the robot; a fifth masking module configured to mask the second image and thereby produce the fifth masked image including the one or more fifth portions of the second image that include the object of interest; and a sixth masking module configured to mask the second image and thereby produce the sixth masked image including the one or more sixth portions of the second image that include the obstacle.

In further features, the first masking and encoding module further includes: a first encoder module configured to encode the first masked image using a neural network; a second encoder module configured to encode the second masked image using the neural network; and a third encoder module configured to encode the third masked image using the neural network.

In further features, the first, second, and third encoder modules are configured to encode the first, second, and third masked images using shared weights for the neural network.

In further features, the neural network module is configured to determine the action using a Markov Decision Process.

In a feature, a computer-implemented method for performing a task composed of a set of primitives with an autonomous device is described and includes: (A) receiving a set of two or more images of a scene, each image in the set including a set of objects with at least one object in the scene being identified as an object of interest to performing the task and one or more additional objects in the scene being identified as obstacle objects; (B) segmenting and masking each image in the set of images with a segmentation module and a masking module to generate for each image (i) a first masked image with the at least one object of interest, (ii) a second masked image with the one or more obstacle objects, and (iii) a third masked image with one or more portions of the autonomous device that are visible in that image; and (C) generating with an encoding module (i) a first image encoding of the first masked image, (ii) a second image encoding of the second masked image, and (iii) a third image encoding of the third masked image; (D) aggregating each respective set of the first, second, and third image encodings into a first aggregated encoding; (E) computing an action for the autonomous device using a neural network policy using the first aggregated encoding; (F) actuating the autonomous device based on the action thereby performing the action with the autonomous device; and (G) repeating (A)-(F) until the task is complete.

In further features, the masking module is configured to generate the first, second, and third masked images using a neural network that shares weights.

In further features, the neural network shares weights across primitives during initialization of a similar primitive.

In further features, the neural network policy further takes as input at least one of (a) one or more measurements from one or more sensors and (b) proprioception of the autonomous device.

In further features, the neural network policy further takes as input at least one of (a) one or more of joint positions of the robot, (b) one or more joint velocities of the robot, (c) an end-effector pose, (d) one or more previous actions from previous times, and (e) a grasp status.

In further features, the autonomous device is one of an autonomous vehicle, a drone, a mobile robot, or a robotic manipulator arm.

In further features, the first, second, and third image encodings are each a vector encoding.

In further features, the set of primitives includes one or more of pick, push, and place.

In further features, the method further includes before (E) aggregating the first aggregated encodings into a second aggregated encoding.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIGS. 1 and 2 are functional block diagrams of example robots;

FIG. 3 is a functional block diagram of an example implementation of a scene representation module;

FIG. 4 is a perspective view of an example implementation of a robot and cameras with different points of view;

FIG. 5 is also a functional block diagram of the example implementation of the scene representation module;

FIG. 6 includes examples of original and masked images;

FIG. 7 includes a functional block diagram illustrating use of the examples of FIGS. 3 and 4; and

FIG. 8 is a flowchart including an example method of controlling a robot.

In the drawings, reference numbers may be reused to identify similar and/or identical elements.

### DETAILED DESCRIPTION

A robot may include two or more cameras at respective different locations with respective fields of view. Images from the cameras and measurements from other sensors of the robot can be used to identify objects captured in the images. One or more actions may be taken based on an identified object. For example, a control module may, based on the detection of one or more objects, control actuation of the robot, such as propulsion, actuation of one or more arms, and/or actuation of a gripper.

Learning robotic manipulation skills from vision may help develop robotics applications that can generalize broadly to real-world scenarios. Object-centric representation may provide better inductive biases for skill learning, leading to improved performance and generalization. Nonetheless, object-centric methods can struggle to learn simple manipulation skills in multi-object environments.

The present disclosure involves processing two or more images from the two or more cameras at the respective different locations in parallel paths. Images may be partitioned for the scene into different semantic groups, such as robot (visible links of the robot), objects (objects to be interacted with), and obstacles (other objects not to be interacted with). This partitioning is done for each image from each camera. Masking is performed to obtain masked red green blue (RGB) images for each semantic group which is concatenated with a binary segmentation mask to form a 4-channel output. The binary segmentation channel provides extra information enabling disambiguation of the segmentation of objects.

Once the masking has been performed, each masked image is processed using a shared convolutional neural network to obtain an image encoding for each group. The final encoding for each image is a concatenation of the three image encodings for the groups of the image. Generally speaking, this provides an object-centric framework that introduces a disentangled representation for objects of interest, obstacles, and robot components.

The masking, processing, and disentanglement into semantic groups and other functionality described herein provide high performance for learning pick and place skills from visual inputs in multi-object environments and generalize at test time to changing objects of interest and distractors in the scene. The masking, processing, and disentanglement also enable the robot to learn to perform manipulation skills in multi-object environments. The masking, processing, and disentanglement into semantic groups and other functionality described herein enable the robot to perform accurately in simulation (simulated environments with simulated objects) and the real world with real objects.

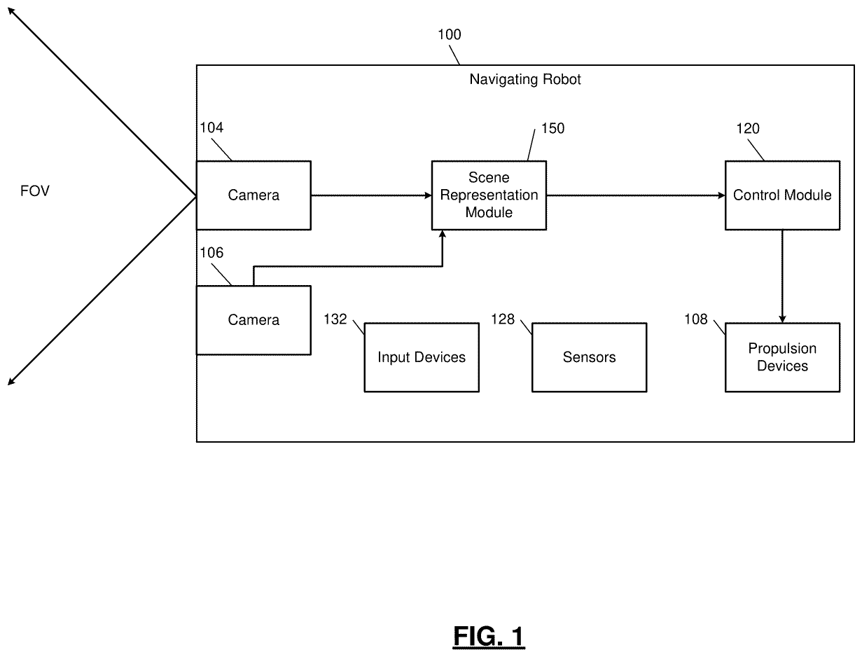

FIG. 1 is a functional block diagram of an example implementation of a navigating robot 100. In the example of FIG. 1, the navigating robot 100 is a vehicle and is mobile. The navigating robot 100 includes a camera 104 that captures images within a predetermined field of view (FOV). The predetermined FOV may be less than or equal to 360 degrees around the navigating robot 100. The operating environment of the navigating robot 100 may be an indoor space (e.g., a building), an outdoor space, or both indoor and outdoor spaces. In various implementations, the camera 104 may be a binocular camera, or two or more cameras may be included in the navigating robot 100.

The camera 104 may be, for example, a grayscale camera, a red, green, blue (RGB) camera, or another suitable type of camera. The camera 104 may or may not capture depth (D) information, such as in the example of a grayscale-D camera or a RGB-D camera. The camera 104 may be fixed to the navigating robot 100 such that the orientation of the camera 104 (and the FOV) relative to the navigating robot 100 remains constant. The camera 104 may update (capture images) at a predetermined frequency, such as 60 hertz (Hz), 120 Hz, or another suitable frequency.

The navigating robot 100 also includes a camera 106, that may be similar or identical to the camera 104. While the example of two cameras is provided, the present disclosure is also applicable to the robot 100 including more than two cameras. The cameras however include at least partially different FOVs. The FOV of the camera 106 may at least at some times at least partially overlap the FOV of the camera 104. In other words, objects in an image from a camera 106 at a time may at least partially be included in an image from the camera 104 taken at the same time.

The navigating robot 100 may include one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The navigating robot 100 is powered, such as via an internal battery and/or via an external power source, such as wirelessly (e.g., inductively).

While the example of a navigating robot is provided, the present disclosure is also applicable to other types of robots with a camera.

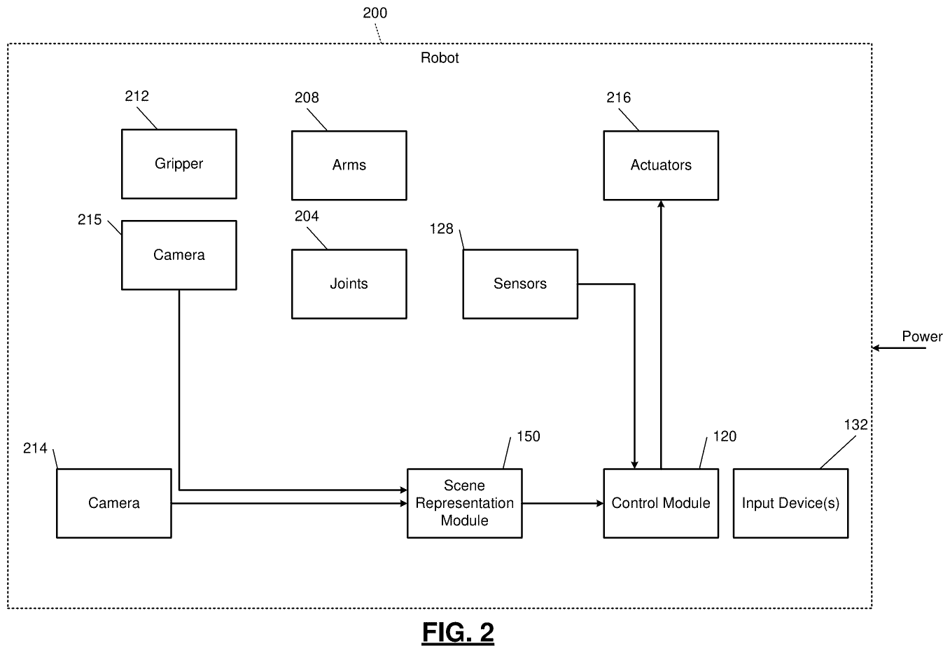

For example, FIG. 2 includes a functional block diagram of an example robot 200. The robot 200 may be stationary or mobile. The robot 200 may be, for example, a 5 degree-of-freedom (DoF) robot, a 6 DoF robot, a 7 DoF robot, an 8 DoF robot, or have another number of degrees of freedom. In various implementations, the robot 200 may include the Panda Robotic Arm by Franka Emika, the mini cheetah robot, or another suitable type of robot. The robot 200 may be a humanoid robot in various implementations.

The robot 200 is electrically powered, such as via an internal battery and/or via an external power source, such as alternating current (AC) power. AC power may be received via an outlet, a direct cabled connection, etc. In various implementations, the robot 200 may receive power wirelessly, such as inductively.

The robot 200 includes a plurality of joints 204 and arms 208. Each arm may be connected between two joints. Each joint may introduce a degree of freedom of movement of a (multi-fingered) gripper 212 of the robot 200. The robot 200 includes actuators 216 that actuate the arms 208 and the gripper 212. The actuators 216 may include, for example, electric motors and other types of actuation devices.

In the example of FIG. 1, a control module 120 controls actuation of the propulsion devices 108. The control module 120 may include one or more processors and memory including instructions that, when executed by the one or more processors, configured the one or more processors to perform the functionality described herein, such as to control actuation of the propulsion devices 108 and, more generally, actuation of the robot.

In the example of FIG. 2, the control module 120 controls the actuators 216 and therefore the actuation (movement, articulation, actuation of the gripper 212, etc.) of the robot 200. The control module 120 may include a planner module configured to plan movement of the robot 200 to perform one or more different tasks. An example of a task includes moving to and grasping (may be referred to as picking) and moving an object and placing (may be referred to as placing) the object at a location. The present disclosure, however, is also applicable to other tasks, such as navigating from a first location to a second location while avoiding objects and other tasks. The control module 120 may, for example, control the application of power to the actuators 216 to control actuation and movement. Actuation of the actuators 216, actuation of the gripper 212, and actuation of the propulsion devices 108 will generally be referred to as actuation of the robot.

The robot 200 also includes a camera 214 that captures images within a predetermined field of view (FOV). The predetermined FOV may be less than or equal to 360 degrees around the robot 200. The operating environment of the robot 200 may be an indoor space (e.g., a building), an outdoor space, or both indoor and outdoor spaces.

The camera 214 may be, for example, a grayscale camera, a red, green, blue (RGB) camera, or another suitable type of camera. The camera 214 may or may not capture depth (D) information, such as in the example of a grayscale-D camera or a RGB-D camera. The camera 214 may be fixed to the robot 200 such that the orientation of the camera 214 (and the FOV) relative to the robot 200 remains constant. The camera 214 may update (capture images) at a predetermined frequency, such as 60 hertz (Hz), 120 Hz, or another suitable frequency. In various implementations, the camera 214 may be a binocular camera, or two or more cameras may be included in the robot 200.

The robot 200 also includes a camera 215, that may be similar or identical to the camera 214. While the example of two cameras is provided, the present disclosure is also applicable to the robot 200 including more than two cameras. The cameras however include at least partially different FOVs. The FOV of the camera 214 may at least at some times at least partially overlap the FOV of the camera 215. In other words, objects in an image from a camera 214 at a time may at least partially be included in an image from the camera 215 taken at the same time.

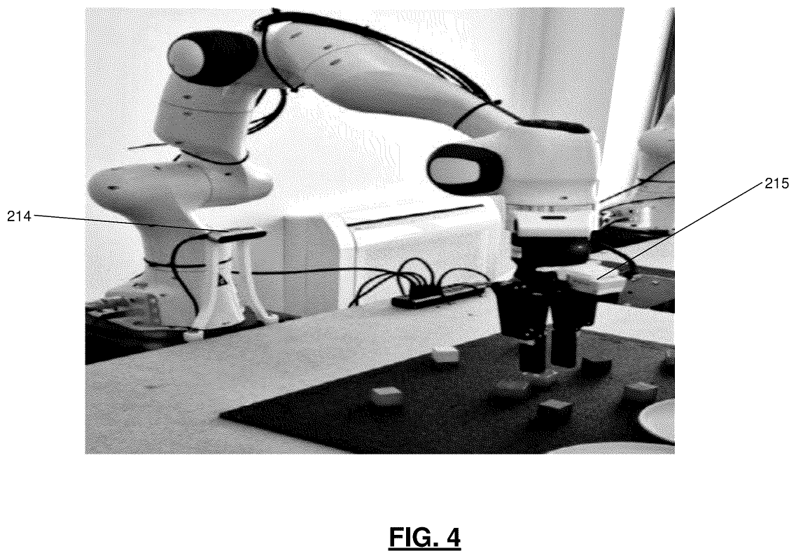

For example, FIG. 4 includes a perspective view of an example implementation of the robot 200. The camera 214 may be implemented on a base component of the robot 200, and the camera 215 may be implemented at a wrist of the robot 200. The wrist may be a joint of the robot closest to the gripper 212. As illustrated, the cameras 214 and 215 may capture at least one or more portions of the same objects in some orientations of the robot 200.

The control module 120 controls actuation of the robot based on one or more images from the cameras. The control module 120 may control actuation additionally or alternatively based on measurements from one or more sensors 128 and/or one or more input devices 132. Examples of sensors include position sensors, temperature sensors, location sensors, light sensors, rain sensors, force sensors, torque sensors, etc. Examples of input devices include touchscreen displays, joysticks, trackballs, pointer devices (e.g., mouse), keyboards, steering wheels, pedals, a microphone, and/or one or more other suitable types of input devices.

For example, the control module 120 may control actuation of the robot based on a scene representation of the space around the robot and objects in space generated by a scene representation module 150. The scene representation module 150 generates the scene representation based on images as discussed further below.

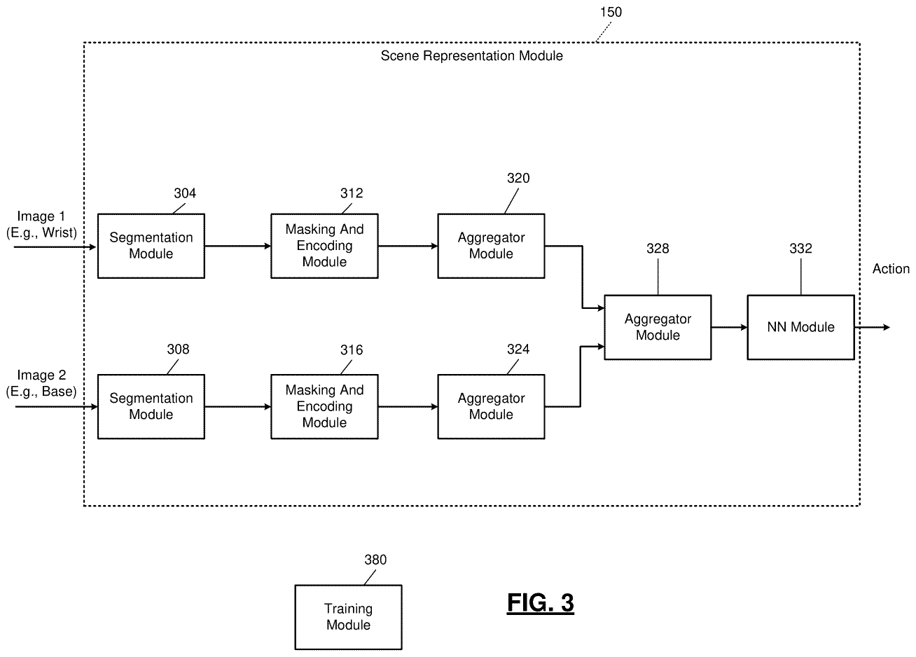

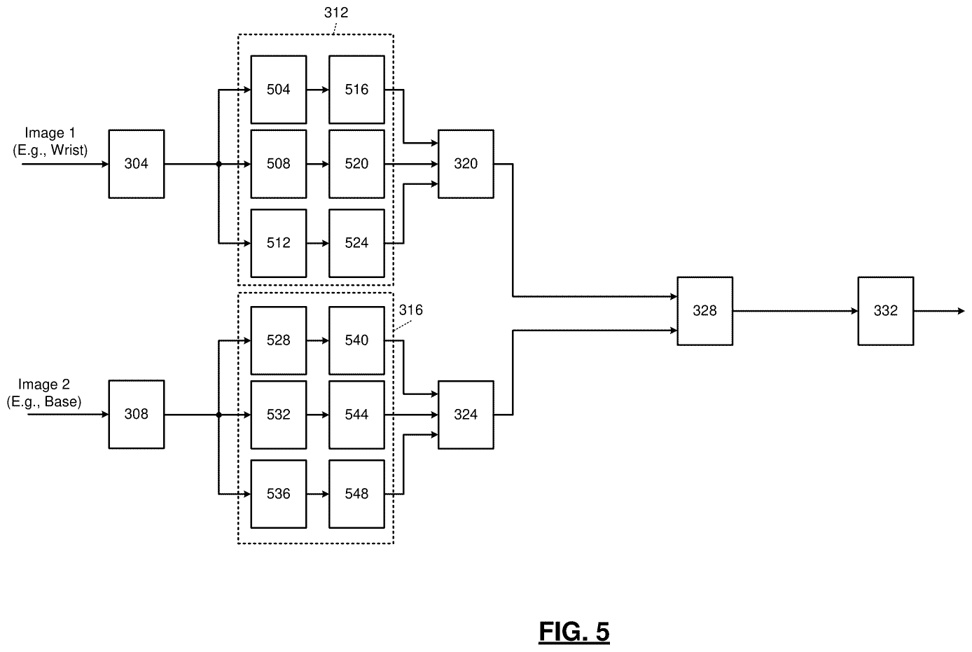

FIG. 3 is a functional block diagram of an example implementation of the scene representation module 150. FIG. 5 is also a functional block diagram of the example implementation of the scene representation module 150.

First and second images (e.g., captured at the same time via two different cameras) are input to the scene representation module 150. For example, the first image (image 1) may be captured from a camera (e.g., 215) at or near a wrist of the robot 200. The second image (image 2) may be captured from a camera (e.g., 214) at or near a base of the robot 200, such as illustrated in FIG. 4. The scene representation module 150 partitions each of the images into three different semantic groups: robot-group including all visible portions of the robot 200 in the image; object-group including objects to be interacted with in an image, which depends on the task/skill to be executed and identifiers (IDS) of the objects of interest; and obstacles-group including all other objects not to be interacted with in the image, but may be obstacles to performing the task/skill. As stated above, while the example of two images is provided, the present disclosure is applicable to more than two images. By using two or more images captured from different points of view at the same time, the approach may be considered multi-view. The scene representation module 150 independently performs a disentanglement process to the images. While the example of one obstacle will be discussed in some places, the present disclosure is also applicable to multiple obstacles and multiple obstacles are often present at a given time.

A first segmentation module 304 segments the first image to obtain segmentations (e.g., outlines) of the objects of interest (object, obstacle, robot) in the first image. The segmentations may include one or more portions of the image outlined at outer edges (boundaries) of each object of interest.

A second segmentation module 308 segments the second image to obtain segmentations of the objects of interest (object, obstacle, robot) in the second image. The segmentations may include one or more portions of the image outlined at edges of each object of interest.

A first masking and encoding module 312 masks areas of the image outside of the segmentations of the first image. As illustrated in FIG. 5, the first masking and encoding module 312 may include a masking module 504 that masks one or more of the object portions, a masking module 508 that masks one or more of the obstacle portions, and a masking module 512 that masks one or more of the robot portions. The masking may include masking (e.g., making white) the areas of the first image outside of the respective objects to create masked images.

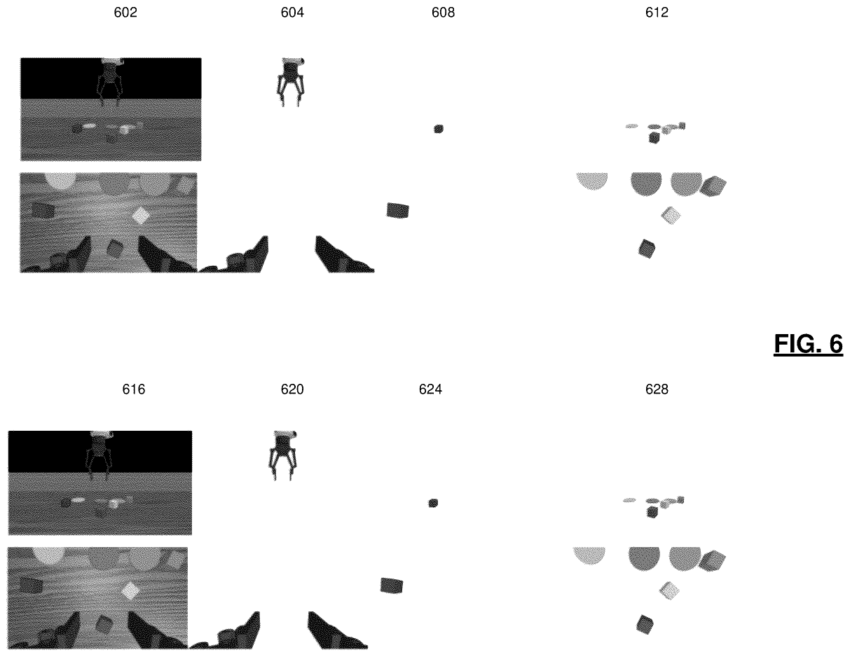

Examples of masked images are illustrated in FIG. 6. 602 illustrates example first and second images. 604 illustrates a masked image for robot components, 608 illustrates a masked image for the objects of interest, and 612 illustrates a masked image for the obstacles. 616 illustrates another example of first and second images. 620 illustrates a masked image for robot components, 624 illustrates a masked image for the objects of interest, and 628 illustrates a masked image for the obstacles. 602 are real world images, while 616 are images in a simulated environment.

The first masking and encoding module 312 encodes the respective maskings. As illustrated in FIG. 5, the first masking and encoding module 312 may include an encoder module 516 that encodes the masked image of the object portions, an encoder module 520 that encodes the masked image of the obstacle portions, and an encoder module 524 that encodes the masked image of the robot portions. In various implementations, the encoder modules 516-524 may encode the masked images using a neural network that shares weights. Such an implementation includes advantages, such as less weights to learn, and multi-task learning is more efficient. In various implementations, the neural network may share weights across skills (primitives) during initialization of a similar task, such as for transfer learning between skills.

A second masking and encoding module 316 masks areas of the image outside of the segmentations of the second image. As illustrated in FIG. 5, the second masking and encoding module 316 may include a masking module 528 that masks one or more of the object portions, a masking module 532 that masks one or more of the obstacle portions, and a masking module 536 that masks one or more of the robot portions. The masking may include masking (e.g., making white) the areas of the first image outside of the respective objects to create masked images.

The second masking and encoding module 316 encodes the respective maskings. As illustrated in FIG. 5, the second masking and encoding module 316 may include an encoder module 540 that encodes the masked image of the object portions, an encoder module 544 that encodes the masked image of the obstacle portions, and an encoder module 548 that encodes the masked image of the robot portions.

A first aggregator module 320 aggregates (e.g., concatenates) the encodings from the first masking and encoding module 312. This produces a camera level aggregated encoding for the objects of interest in the first image.

A second aggregator module 324 aggregates (e.g., concatenates) the encodings from the second masking and encoding module 316. This produces a camera level aggregated encoding for the objects of interest in the second image.

In various implementations, a single encoding module may be used to perform the encoding of the encoding module 312 and the encoding module 316 in series, and/or a single aggregator module may be used to perform the aggregation of the first aggregator module 320 and the second aggregator module 324 in series.

A third aggregator module 328 aggregates (e.g., concatenates) the camera level aggregated encodings from the first and second aggregator modules 320 and 324. This produces a scene level aggregated encoding (scene representation) for the objects of interest in the first and second images.

A neural network (NN) module 332 includes one or more skill policies (Tt) for the robot 200. The NN module 332 determines an action for the robot 200 to execute at that time based on the scene level aggregated encoding. The control module 120 actuates the actuators 216 and/or the gripper 212 of the robot 200 thereby executing the action.

The neural network module 332 may determine the action further based on one or more measurements from one or more sensors of the robot 200 and/or proprioception (e.g., perception or awareness of the position and movement of the body) of the robot 200. For example, the neural network module 332 may determine the action further based on one or more of (a) one or more of joint positions of the robot, (b) one or more joint velocities of the robot, (c) an end-effector pose, (d) one or more previous actions from previous times, respectively, and (e) a grasp (e.g., gripper) status. In various implementations, the neural network module 332 may determine the action further based on one or more other parameters, such as a previous scene level aggregated encoding. This may provide information regarding the camera observational history.

In various implementations, a training module 380 may train the segmentation modules 304 and 308, the aggregator module 320 and 324, and the aggregator module 328. The training module 380 may not train the encoder modules 516, 520, 524, 540, 544, and 548, and may not train the NN module 332. In various implementations, training may be performed end-to-end from the aggregator module(s) forward.

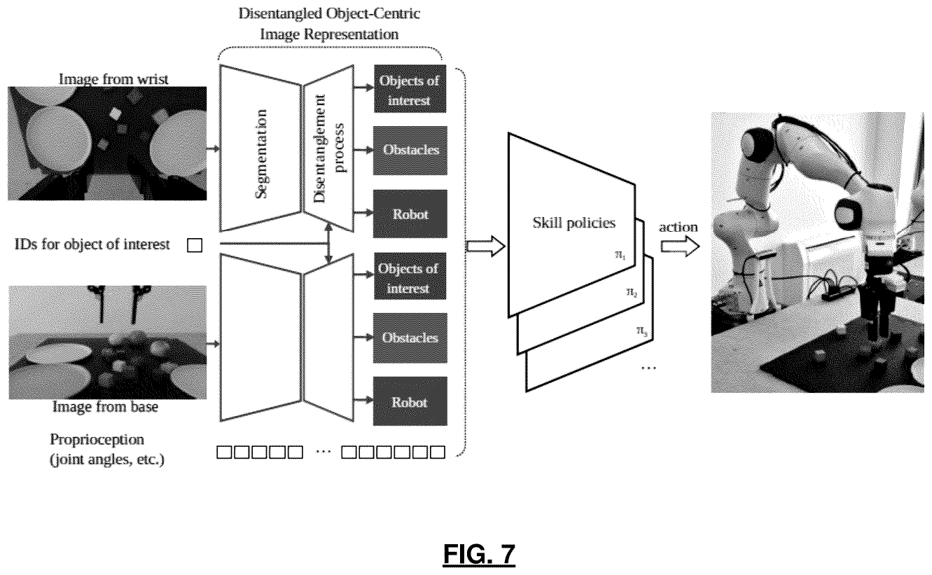

FIG. 7 includes a functional block diagram illustrating use of the examples of FIGS. 3 and 4.

Generally speaking, the scene representation module 150 generates a structured object-centric image representation by partitioning images for each scene view (image) into three semantic groups, namely: robot group includes all visible links of the robot in the images, Objects group includes the object(s) to be interacted with in the images, which depends on the skill to be executed and the IDs of the object(s) of interest, and obstacles group which includes all other objects not to be interacted with in the image.

The above disentanglement process is applied independently to the images from both views. Given a camera view image, the scene representation module 150 first obtains a global segmentation of each image into its constituent objects. Next, the scene representation module 150 partitions the segmentations segmentation into three binary segmentation masks corresponding to the three semantic groups according to the current skill. For each group, the scene representation module 150 also applies segmentation mask to the camera observation to obtain a masked RGB image, which is aggregated (e.g., concatenated) with the binary segmentation mask to form a 4-channel image by the modules 312 and 316. The binary segmentation channel provides extra information enabling, for example, disambiguation of the segmentation of objects having a white color, which may be used for masking.

Once the masked observations are obtained, the scene representation module 150 may process each masked image with a shared convolutional neural network (e.g., 516-524 and 540-548) to obtain an image encoding for each group. The final camera level representation encoding I is a concatenation of the three image encodings, which may be expressed as

$$I = [ CNN ( robot ) \vert \vert CNN ( objects ) \vert \vert CNN ( obstacles ) ] .$$

These camera level representations are aggregated (e.g., concatenated), so the final scene representation therefore includes the two camera level encodings {I_{base}, I_{wrist}}.

In various implementations, the training module 380 may train the neural network module 332 using reinforcement learning (RL), such as model-free RL.

Regarding determining the action, the neural network module 332 may determine the action using a Markov Decision Process M= [symbol] S, A, P, R [symbol] where S is the state space including the two images from the multi-view cameras, along with robot proprioception variables (joint positions, joint velocities, end-effector pose, previous action, and Boolean grasp status). A is the action space with actions a∈ [symbol] split into two parts: aₐᵣₘ∈[−1, 1]³ is a 3D normalized end-effector displacement command, and a_{gripper}∈{−1, 1} is a Boolean action to open or close the gripper. P is an (e.g., unknown) transition function defining the environment dynamics, and R is a reward function including skill-specific terms such as reaching, grasping, and obstacle avoidance. The training module 380 may train the policies of the neural network module 332 using proximal policy optimization (PPO) in various implementations.

In various implementations, the skill policies of the neural network module 332 may include multi-layer perceptrons (MLPs). In various implementations, the skill policies may not include self-attention mechanisms. In various implementations, the robot 200 may be a 7-DOF Franka panda arm equipped with a two finger gripper (e.g., Robotiq model 2F-140). In various implementations, camera 214 may be the RealSense model D435 camera and be attached at or near the base of the robot 200 and capture a global view of the scene. The camera 215 may be, for example, the RealSense model D405 camera and capture a closer view for manipulation.

In various implementations, the segmentation modules 304 and 308 may include a visual transformer (ViT)-small DINOv2 model, such as described in M. Oquab, et al., “Dinov2: Learning robust visual features without supervision”, arXiv:2304:07193, 2023, which is incorporated herein in its entirety. Although the exemplary visual transformer in these exemplary implementations is the DINOv2 model, any other visual transformer model similar to DINOv2 may be used that is a self-supervised visual foundation model designed to learn general-purpose visual features from images without using any labels. Such a self-supervised visual foundation model may produce image representations that are robust and transferable across many vision tasks (such as classification, segmentation, and depth estimation) without fine-tuning. Classifications for the groups may be determined by the segmentation modules 304 and 308 for example, using a Segment Anything Model 2 (SAM2), which is described in N. Ravi, et al., “Sam 2: Segment anything in images and videos”, ArXiv:2408:00714, 2024, which is incorporated herein in its entirety. Although the SAM 2 model is described in these exemplary implementations, any visual foundation model for promptable segmentation that works on both images and videos may be used. Such a visual foundational model may handle temporal information efficiently and effectively in videos as well.

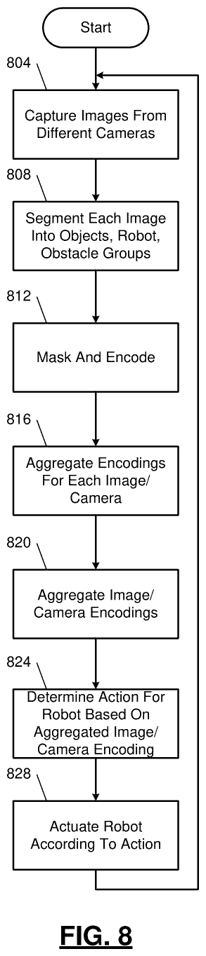

FIG. 8 is a flowchart including an example method of controlling a robot. Control begins where the cameras of the robot capture images, respectively, such as at the same time or approximately the same time. Approximately may mean, for example, within 0.1 seconds. The images are input to the scene representation module 150.

At 808, the segmentation modules 304 and 408 respectively segment the images into the segmentations for the robot, obstacle, and object groups. At 812, the masking and encoding modules 312 and 316 respectively mask the segmentations as discussed above. At the masking and encoding modules 312 and 316 respectively encode the masked segmented images as discussed above.

At 816, the aggregator modules 320 and 324 aggregates the encodings from the masking and encoding modules 312 and 316, respectively, as discussed above. At 820, the aggregator module 328 aggregates the aggregated encodings from the aggregator modules 320 and 324 to generate the scene level representation (e.g., vector).

At 824, the neural network module 332 determines an action to be taken by the robot based on the scene level representation as discussed above, such as using a Markov Decision Process. At 828, the control module 120 actuates the actuators 216 and/or the gripper 212 to perform the action to be taken. Control returns to 804 for a next iteration of actuating the robot toward completing a task, such as picking or placing an object.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A robot control system for performing a task, comprising:
a first segmentation module configured to:
receive a first image from a first camera of a robot having a first point of view; and
segment the first image into (a) one or more first portions of the first image that include the robot, (b) one or more second portions of the first image that include an object of interest to performing the task, and (c) one or more third portions of the first image that include an obstacle;
a second segmentation module configured to:
receive a second image from a second camera of the robot having a second point of view, the second point of view different than the first point of view; and
segment the second image into (a) one or more fourth portions of the second image that include the robot, (b) one or more fifth portions of the second image that include the object of interest, and (c) one or more sixth portions of the image that include the obstacle;
a first masking and encoding module configured to:
mask the first image and produce (a) a first masked image including the one or more first portions of the first image that include the robot, (b) a second masked image including the one or more second portions of the first image that include the object of interest, and (c) a third masked image including the one or more third portions of the first image that include the obstacle; and
encode the first, second, and third masked images into first, second, and third encodings, respectively;
a second masking and encoding module configured to:
mask the second image and produce (a) a fourth masked image including the one or more fourth portions of the second image that include the robot, (b) a fifth masked image including the one or more fifth portions of the second image that include the object of interest, and (c) a sixth masked image including the one or more sixth portions of the second image that include the obstacle; and
encode the fourth, fifth, and sixth masked images into fourth, fifth, and sixth encodings, respectively;
one or more of a first aggregator module and a second aggregator module configured to (i) aggregate the first, second, and third encodings into a seventh encoding and to (ii) aggregate the fourth, fifth, and sixth encodings into an eighth encoding;
a neural network module configured to determine an action to be taken by the robot for completing the task based on the seventh and eighth encodings; and
a control module configured to actuate the robot based on the action.

2. The robot control system of claim 1 further comprising a third aggregator module configured to aggregate the seventh and eighth encodings into a ninth encoding,
wherein the neural network module is configured to determine the action to be taken by the robot for completing the task based on the ninth encoding.

3. The robot control system of claim 2 wherein the third aggregator module is configured to generate the ninth encoding by concatenating the seventh and eighth encodings.

4. The robot control system of claim 1 wherein the one or more of the first aggregator module and the second aggregator module is configured to:
generate the seventh encoding by concatenating the first, second, and third encodings; and
generate the eighth encoding by concatenating the fourth, fifth, and sixth encodings.

5. The robot control system of claim 1 wherein:
the first segmentation module is configured to segment the first image using a visual transformer model; and
the second segmentation module is configured to segment the second image using the visual transformer model.

6. The robot control system of claim 1 wherein the neural network module is configured to determine the action using skill policies.

7. The robot control system of claim 6 wherein the skill policies include multi-layer perceptrons (MLPs).

8. The robot control system of claim 1 wherein the neural network module is configured to determine the action further based on at least one of: (a) one or more measurements from one or more sensors of the robot and (b) proprioception of the robot.

9. The robot control system of claim 1 wherein the neural network module is configured to determine the action further based on at least one of (a) one or more joint positions, (b) one or more joint velocities, (c) an end-effector pose, (d) previous instance of the action from a previous time, and (e) a grasp status.

10. The robot control system of claim 1 wherein the first masking and encoding module includes:
a first masking module configured to mask the first image and thereby produce the first masked image including the one or more first portions of the first image that include the robot;
a second masking module configured to mask the first image and thereby produce the second masked image including the one or more second portions of the first image that include the object of interest; and
a third masking module configured to mask the first image and thereby produce the third masked image including the one or more third portions of the first image that include the obstacle.

11. The robot control system of claim 10 wherein the second masking and encoding module includes:
a fourth masking module configured to mask the second image and thereby produce the fourth masked image including the one or more fourth portions of the second image that include the robot;
a fifth masking module configured to mask the second image and thereby produce the fifth masked image including the one or more of fifth portions of the second image that include the object of interest; and
a sixth masking module configured to mask the second image and thereby produce the sixth masked image including the one or more of sixth portions of the second image that include the obstacle.

12. The robot control system of claim 10 wherein the first masking and encoding module further includes:
a first encoder module configured to encode the first masked image using a neural network;
a second encoder module configured to encode the second masked image using the neural network; and
a third encoder module configured to encode the third masked image using the neural network.

13. The robot control system of claim 12 wherein the first, second, and third encoder modules are configured to encode the first, second, and third masked images using shared weights for the neural network.

14. The robot control system of claim 1 wherein the neural network module is configured to determine the action using a Markov Decision Process.

15. A computer-implemented method for performing a task composed of a set of primitives with an autonomous device, the method comprising:
(A) receiving a set of two or more images of a scene, each image in the set including a set of objects with at least one object in the scene being identified as an object of interest to performing the task and one or more additional objects in the scene being identified as obstacle objects;
(B) segmenting and masking each image in the set of images with a segmentation module and a masking module to generate for each image (i) a first masked image with the at least one object of interest, (ii) a second masked image with the one or more obstacle objects, and (iii) a third masked image with one or more of portions of the autonomous device that are visible in that image; and
(C) generating with an encoding module (i) a first image encoding of the first masked image, (ii) a second image encoding of the second masked image, and (iii) a third image encoding of the third masked image;
(D) aggregating each respective set of the first, second, and third image encodings into a first aggregated encoding;
(E) computing an action for the autonomous device using a neural network policy using the first aggregated encoding;
(F) actuating the autonomous device based on the action thereby performing the action with the autonomous device; and
(G) repeating (A)-(F) until the task is complete.

16. The computer-implemented method of claim 15, wherein the masking module is configured to generate the first, second, and third masked images using a neural network that shares weights.

17. The computer-implemented method of claim 16, wherein the neural network shares weights across primitives during initialization of a similar primitive.

18. The computer-implemented method of claim 15, wherein the neural network policy further takes as input at least one of (a) one or more measurements from one or more sensors and (b) proprioception of the autonomous device.

19. The computer-implemented method of claim 18, wherein the neural network policy further takes as input at least one of (a) one or more of joint positions of the robot, (b) one or more joint velocities of the robot, (c) an end-effector pose, (d) one or more previous actions from previous times, and (e) a grasp status.

20. The computer-implemented method of claim 15, wherein the autonomous device is one of an autonomous vehicle, a drone, a mobile robot, or a robotic manipulator arm.

21. The computer-implemented method of claim 15, wherein the first, second, and third image encodings are each a vector encoding.

22. The computer-implemented method of claim 15, wherein the set of primitives includes one or more of pick, push, and place.

23. The computer-implemented method of claim 15, further comprising before (E) aggregating the first aggregated encodings into a second aggregated encoding.
